(19) United States
(12) Patent Application Publication
(10) Pub. No.: US 2009/0325414 A1
(43) Pub. Date: Dec. 31, 2009

(54) SECURE DIGITAL MEMORY CARD RETAINING MECHANISM

(75) Inventor: Chin-Yung Peng, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/330,600

(22) Filed: Dec. 9, 2008

(30) Foreign Application Priority Data
Jun. 30, 2008 (CN) 200810302440.7

(51) Int. Cl. H01R 13/62

(52) U.S. Cl. 439/327

(57) ABSTRACT

A secure digital memory card (SD card) retaining mechanism (100) includes a receiving member (10), an antenna (20) and a circuit board (40). The receiving member receives an SD card therein. The antenna is integrated with the receiving member. Both the receiving member and the antenna are electronically connected to the circuit board.

### BACKGROUND

1. Field of the Invention

The present invention relates to a secure digital memory card (SD card) retaining mechanism, and particularly to a multifunctional SD card retaining mechanism.

2. Description of Related Art

Secure digital memory card (SD card) are widely used in many portable electronic devices, such as mobile phones, personal digital assistants and digital cameras. The SD card is configured for storing information therein. Retaining mechanisms are used in these portable electronic devices for receiving the SD cards. The retaining mechanism is mounted on a circuit board of a portable electronic device. When the SD card is received in the retaining mechanism, it is electronically connected to the circuit board through the retaining mechanism.

The retaining mechanism usually takes up a lot of space in a portable electronic device when mounted therein. Further, the retaining mechanism generally does not have other functionality except for receiving and retaining the SD card. Thus, the retaining mechanism may prevent miniaturization of the portable electronic device.

Therefore, there is room for improvement within the art.

### BRIEF DESCRIPTION OF THE DRAWINGS

Many aspects of the present secure digital memory card (SD card) retaining mechanism can be better understood with reference to the following drawings. The components in the various drawings are not necessarily drawn to scale, the emphasis instead being placed upon clearly illustrating the principles of the present SD card retaining mechanism. Moreover, in the drawings, like reference numerals designate corresponding parts throughout the figures.

FIG. 1 is an assembled, schematic view of an SD card retaining mechanism, according to a first exemplary embodiment.

FIG. 2 is a disassembled, schematic view of the SD card mechanism shown in FIG 1.

FIG. 3 is a schematic view of an SD card retaining mechanism, according to a second exemplary embodiment.

### DETAILED DESCRIPTION OF THE EXEMPLARY EMBODIMENT

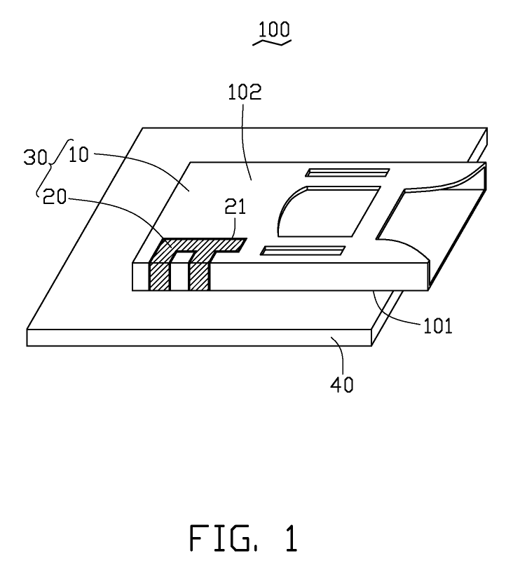

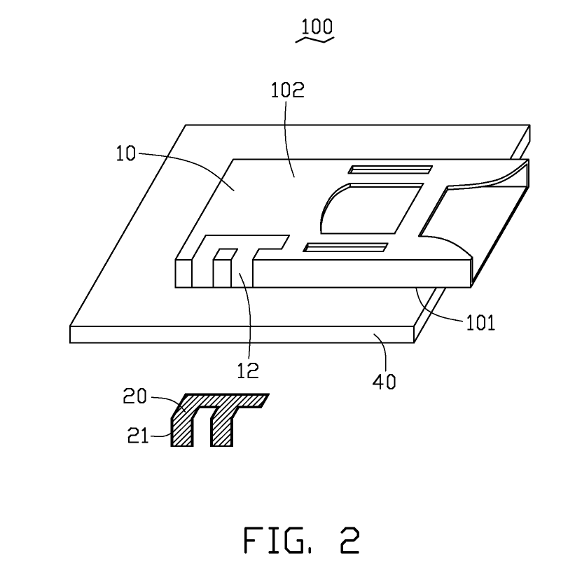

FIG. 1 and FIG. 2 show a secure digital memory card (SD card) retaining mechanism 100 according to a first exemplary embodiment. The retaining mechanism 100 is used in a portable electronic device (not shown), such as a mobile phone, to receive an SD card (not shown).

The retaining mechanism 100 includes a receiving member 10, an antenna 20 and a circuit board 40. The receiving member 10 is integrated with the antenna 20 to form a rectangular box 30 to receive the SD card therein. The circuit board 40 is part of the inner circuitry of the portable electronic device. Both the receiving member 10 and the antenna 20 are mounted on the circuit board 40 to form electronic connections.

The receiving member 10 is a substantially rectangular case made of conductive materials, such as metal. A conventional circuit (not shown) configured for connecting the SD card to the circuit board 40 is formed in the receiving member 10. A first surface 101 of the receiving member 10 is secured and electronically connected to the circuit board 40. When the SD card is received in the receiving member 10, it is electronically connected to the circuit board 40 through the receiving member 10. The receiving member 10 defines a gap 12 having a shape and a size corresponding to the antenna 20 on an exposed surface 102.

The antenna 20 is a planar antenna, such as an inverted F antenna or other microstrip antenna. The portable electronic device can receive and send wireless electronic signals through antenna 20. The antenna 20 is made of the same material as the receiving member 10, or other conductive materials, and includes an insulated portion 21 formed on its peripheral region. The antenna 20 is mounted on the circuit board 40, and engages in the gap 12, thus integrates with the receiving member 10 to form a box 30 to receive the SD card therein. In use, the insulated portion 21 insulates the antenna 20 with the receiving member 10 to prevent a short circuit.

During fabrication, the receiving member 10 and the antenna 20 can each be made through conventional methods, such as injection molding, and the antenna 20 is engaged in the gap 12 of the receiving member 10 to form the box 30. The box 30 is fixed on the circuit 40, and the receiving member 10 and the antenna 20 are respectively electronically connected to the circuit board 40. Thus, the retaining mechanism 100 and the antenna 20 integrated therein can be used.

Further, since the receiving member 10 and the antenna 20 can be made of the same materials, the retaining mechanism 100 can also be fabricated using another method. In this method, a box 30 made of conductive materials is provided. A part of the box 30 having a predetermined shape of the antenna 20, such as an inverted F, is separated from the box 30 by, e.g., cutting, thereby defining the gap 12 in the box 30. The insulated portion 21 is formed on a peripheral region of the antenna part by conventional means, such as spraying insulated print to form a print layer. In this way, the antenna 20 is provided. Circuits configured for connecting with an SD card are formed in another part of the box 30, which defines the receiving member 10. Finally, the antenna 20 is received in the gap 12. Both the antenna 20 and the receiving member 10 are mounted and electronically connected to the circuit board 30, thus the retaining mechanism 100 is provided.

The gap 12 can be defined at any portion of the receiving member 10 to receive the antenna 20. However, advantageously, the gap 12 is usually defined on exposed parts, such as the second surface 102 of the receiving member 10 allowing the antenna 20 received to have a better communicating effect. Additionally, the insulated portion 21 can also be formed on parts of the receiving member 10 that contacts the antenna 20.

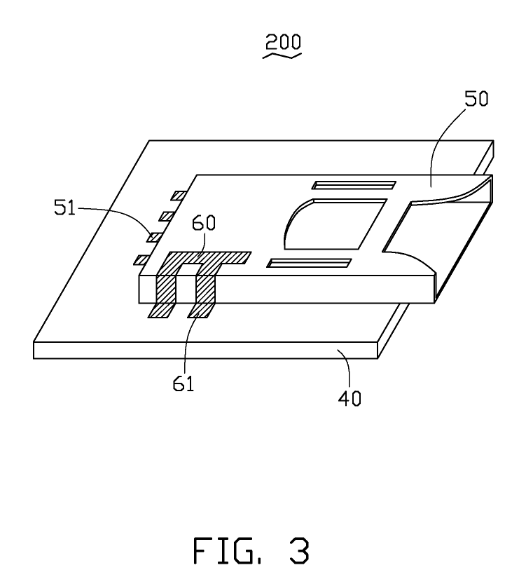

Referring to FIG. 3, an SD card retaining mechanism 200 according to a second exemplary embodiment is provided. The retaining mechanism 200 includes a receiving member 50 configured for receiving the SD card therein, an antenna 60 integrated with the receiving member 50, and a circuit board 40 similar to that of the retaining mechanism 100. The receiving member 50 is mounted on the circuit board 40, the antenna 60 is formed on a surface of the receiving member 50. Both the receiving member 50 and the antenna 60 are electronically connected to the circuit 40.

The receiving member 50 is a substantially rectangular case having a shape similar to the box 30. The receiving member 50 can be made of insulated materials, such as plastics, and includes a plurality of connectors 51 formed thereon. When the SD card is received in the receiving member 50, it is electronically connected to the circuit board 40 through the connectors 51.

The antenna 60 is a planar antenna made of conductive materials, such as metal. The antenna 60 is directly formed on a part of a surface of the receiving member 50. The shape of the antenna 60 can be similar to that of the antenna 20. The antenna 60 includes a plurality of connecting portions 61, which are parts of the antenna 60 extending to a side of the receiving member 50. When the receiving member 50 is mounted on the circuit board 40, the antenna 60 can be electronically connected to the circuit board 40 through the connecting portions 61. Further, the antenna 60 can also be electronically connected to the circuit board 40 through the connectors 51, if only the connectors 51 connecting the antenna 60 with the circuit board 40 are insulated with other connectors 51 connecting the SD card with the circuit board 40.

During fabrication, the receiving member 10 is made by means of conventional means, such as injection molding. The antenna 60 is then formed on an exposed surface of the receiving member 10 by means of spraying, plating, etc. Finally, the receiving member 10 is fixed on the circuit board 40. The receiving member 10 is electronically connected to the circuit board 40 through the connectors 51, and the antenna 60 is electronically connected to the circuit board 40 through the connecting portions 61 and/or the connectors 51. Thus, the retaining mechanism 200 is provided.

In the exemplary embodiments, the antenna 20/60 is integrated with the receiving member 10/50, without occupying any additional space. Therefore, space for a conventional antenna in a portable electronic device is saved. Thus, the retaining mechanism 100/200 becomes multifunctional, without increasing its size, and at the same time, achieves miniaturization requirement of the portable electronic device.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A secure digital memory card (SD card) retaining mechanism, comprising:
a receiving member configured for receiving an SD card therein;
an antenna integrated with the receiving member; and
a circuit board, both the receiving member and the antenna being electronically connected to the circuit board.

2. The SD card retaining mechanism as claimed in claim 1, wherein the receiving member is a case made of conductive material and mounted on the circuit board.

3. The SD card retaining mechanism as claimed in claim 1, wherein the antenna is a planar antenna mounted on circuit board.

4. The SD card retaining mechanism as claimed in claim 1, wherein the receiving member defines a gap corresponding to the antenna therein, and the antenna engages in the gap.

5. The SD card retaining mechanism as claimed in claim 4, wherein the receiving member and the antenna are respectively formed by separate parts of a box made of conductive material.

6. The SD card retaining mechanism as claimed in claim 4, wherein the antenna includes an insulated portion formed on its peripheral portion to insulate the antenna and the receiving member.

7. The SD card retaining mechanism as claimed in claim 4, wherein the receiving member includes an insulated portion formed on parts thereof that contacts the antenna to insulate the antenna and the receiving member.

8. The SD card retaining mechanism as claimed in claim 1, wherein the receiving member is a case made of insulated material and mounted on the circuit board.

9. The SD card retaining mechanism as claimed in claim 8, wherein the receiving member includes a plurality of connectors formed thereon and configured for connecting the SD card received therein to the circuit board.

10. The SD card retaining mechanism as claimed in claim 9, wherein the antenna is electronically connected to the circuit board by the connectors.

11. The SD card retaining mechanism as claimed in claim 8, wherein the antenna is a planar antenna formed on a surface of the receiving member.

12. The SD card retaining mechanism as claimed in claim 11, wherein the antenna includes a plurality of connecting portions extending to a side of the receiving member to electronically connect the antenna to the circuit board.
